(19) United States
(12) Patent Application Publication
(10) Pub. No.: US 2003/0009117 A1
(43) Pub. Date: Jan. 9, 2003

(54) Kneading head of massage machine

(76) Inventor: Jian-Han Zou, Fujian (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 09/897,887

(22) Filed: Jul. 5, 2001

(51) Int. Cl. A61H 7/00

(52) U.S. Cl. 601/134; 601/112

(57) ABSTRACT

The present invention provides a kneading head of massage machine that consists of a connecting rod and a set of spherical heads. One set of the spherical heads includes two and more; all the spherical heads located on ends of the connecting rod in different heights, or all the spherical heads can be integrated with the connecting rod into a whole body. When the massage machine adapting the kneading head is used on the human body, the stepped spherical heads will effort a great pushing force and a great pressing force on surface and deeper skin of the muscle of the human body simultaneously at different heights and positions so as to carry on massage in kneading method with a better effect for meeting the necessaries of the customers.

### BACKGROUND OF THE INVENTION

1. Field of the Invention

The present invention relates to a kneading head of massage machine.

2. Description of Prior Art

In accordance with the conventional massage machine, the kneading function is carried on by driving a couple of symmetry kneading heads spinning in counter-motion with a motor directly. The kneading head of the massage machine is a simple half-ball head retained on a spindle, depending on the different real-operation, although there are single head (one spindle attached with a half-ball head), double heads (one spindle with two half-ball heads), triple heads (one spindle with three half-ball heads), and so on, but also because all the kneading heads are in a same height, so during the kneading process, the symmetry kneading heads massage the muscle of body in a certain effect, and there is another massage machine simulating the fingers of human to knead the muscle of human, but the massage effects of the both of them are dull not to get to desired level of the customer.

### OBJECTS AND SUMMARY OF THE INVENTION

It is therefore a main object of the present invention to provide a kneading head of massage machine, which can create the better massage effect for meeting the desired level of the customer.

This object is achieved by the present invention, wherein the kneading head of massage machine typically consists of a connecting rod and a set of spherical heads. One set of the spherical heads includes two and more. All the spherical heads are located on ends of the connecting rod in different heights.

Therein, a number of plug-in sockets coordinating to the number of the spherical heads are formed on the ends of the connecting rod, and every spherical head extends out a square plug-in pin downward with a ring groove approaching the bottom end, for plugging into the plug-in socket and located by setting a binding ring into the ring groove, so in this way all the spherical heads are located on the ends of the connecting rod individually by the binding rings clamping into the ring grooves at the bottom of the spherical heads.

In another operation, all the spherical heads can be integrated with the connecting rod into a whole body in molding.

Said a set of spherical heads includes two pieces located on the both ends of an I-shaped connecting rod in different height separately.

Said a set of spherical heads includes three pieces located on the three ends of a Y-shaped connecting rod in different heights separately.

Said a set of spherical heads includes four pieces located on the four ends of a X-shaped connecting rod in different heights separately.

Due to adapting above-mentioned structure, the kneading head of the present invention has a set of stepped spherical heads, all the spherical heads are located on the spindle via the connecting rod, so that every spherical head has its individual own track not keeping on the axial line of the spindle as running, in operation when a motor drives two sets of kneading heads in counter-motion, the stepped spherical heads will effort a great pushing force and a great pressing force on surface and deeper skin of the muscle of the human body simultaneously at different heights and positions so as to carry on massage in kneading method with a better effect for meeting the necessaries of the customers.

### BRIEF DESCRIPTION OF THE DRAWINGS

FIG. 1 is an exploded view showing the first operation of the present invention.

FIG. 2 is an exploded view showing the mechanism of massage machine with the kneading heads shown in FIG. 1 of the present invention.

FIG. 3 is a solid view of FIG. 2.

FIG. 4 is a solid view showing the uncovered state of FIG. 3.

FIG. 5 is a solid view showing the exterior of the goods of FIG. 4.

FIG. 6 is a scheme showing a using state (1) of FIG. 5.

FIG. 7 is a scheme showing a using state (2) of FIG. 5.

FIG. 8 is a solid view showing the second operation of the present invention.

FIG. 9 is an exploded view showing the third operation of the present invention.

FIG. 10 is an exploded view showing the fourth operation of the present invention.

### DETAILED DESCRIPTION OF PREFERRED EMBODIMENTS

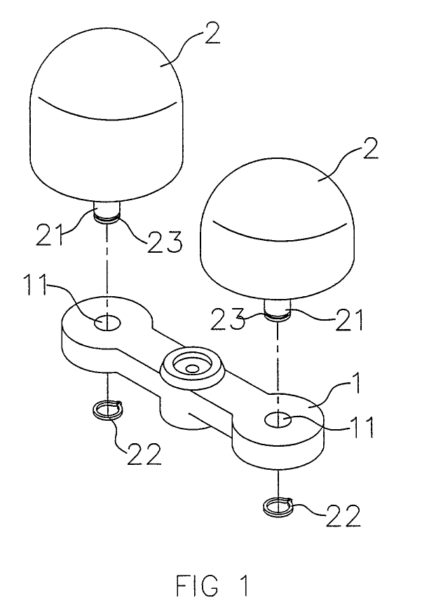

Referring to FIG. 1, the present invention includes a kneading head of massage machine, which consists of a connecting rod 1 and a set of spherical heads 2. Said a set of spherical heads 2 includes two pieces.

Wherein, said connecting rod 1 appears into I-shaped with two plug-in sockets 11 at both ends.

Two spherical heads 2 are not in a same height, and have a square plug-in pin 21 at bottom side individually, and a ring groove 23 formed approaching the bottom end.

As combining the two spherical heads 2 on the connecting rod 1, plug the plug-in pin 21 into the plug-in socket 11, and retain it by setting a binding ring 22 into the ring groove 23 at the back side, by means of the retaining function of the bottom end and the binding ring 22, the both spherical heads 2 are located on the both ends of the connecting rod 1.

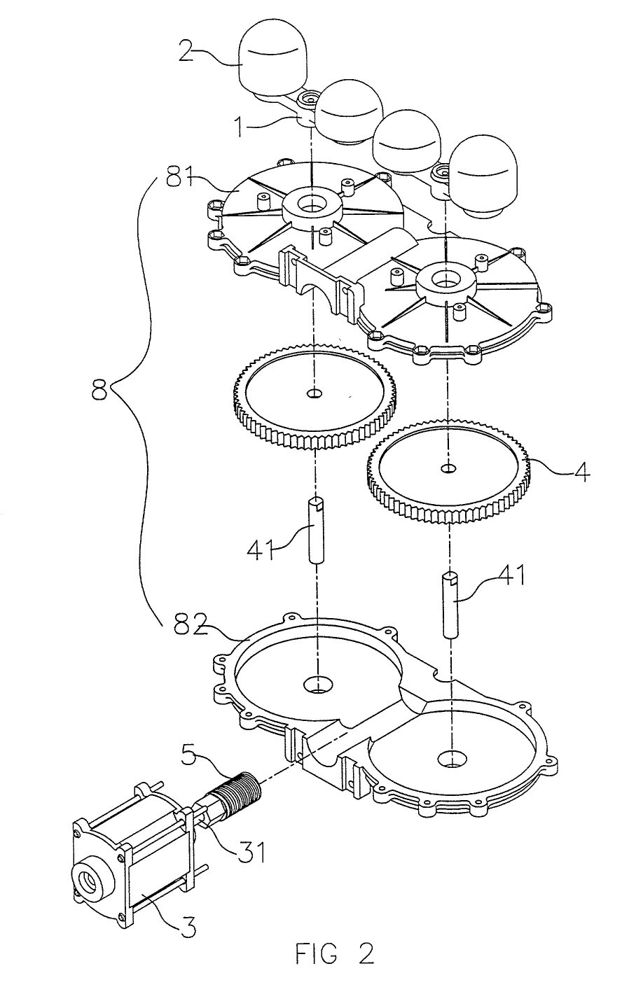

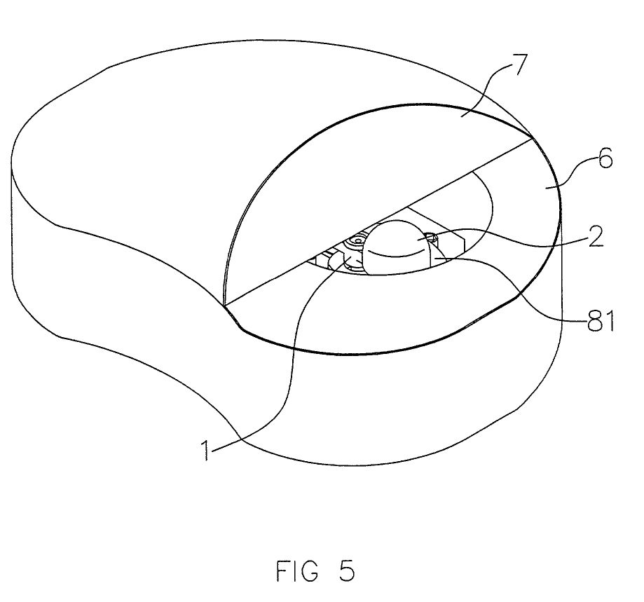

Referring to FIG. 2 and FIG. 5, the massage machine provided by the present invention typically comprises a motor 3, a worm wheel 4 and a worm 5, in the preferred embodiment provided by the present invention, all the components are installed into a shell 6 that is made of foamed material for reducing the weight, and cover a leather cover 7 on the shell 6 so that all the components are enclosed in the inside space surrounded by the shell 6 and the leather cover 7 to form an independent massage cushion for leaning on as shown in FIG. 5. Certainly, all the components also can be mounted into the chair or mattress directly in the same principle. In this text, former is described just only.

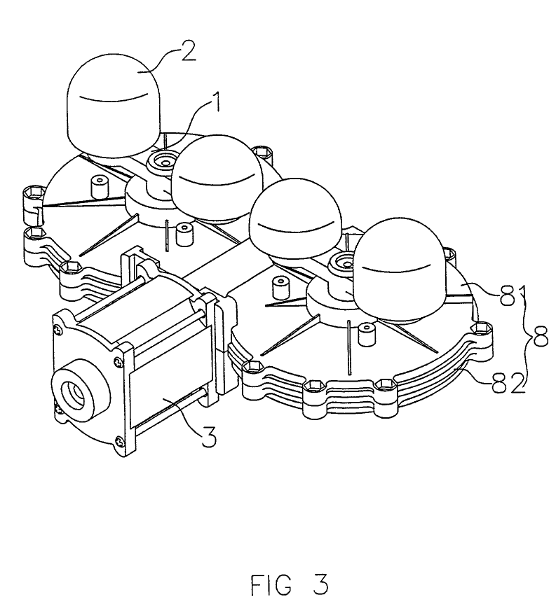

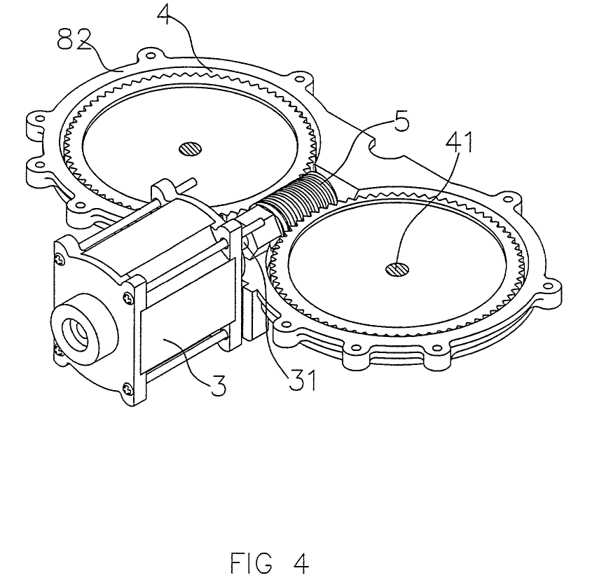

Referring to FIG. 3 and FIG. 4, the worm wheel 4 and the worm 5 are mounted into a gearbox 8 that is closed with an upper case 81 and a low case 82, and the motor 3 is located on one side of the gearbox 8, and extends its axle into the inside of the gearbox 8 and secured with the worm 5, which gears with two worm wheels 4 at both sides simultaneously; said two worm wheels 4 are secured on two shafts 41 separately, every shaft 41 extends its tip end out of the gearbox 8 at the same side to connect with the center of the connecting rod 1 attaching with two spherical heads 2 in different heights.

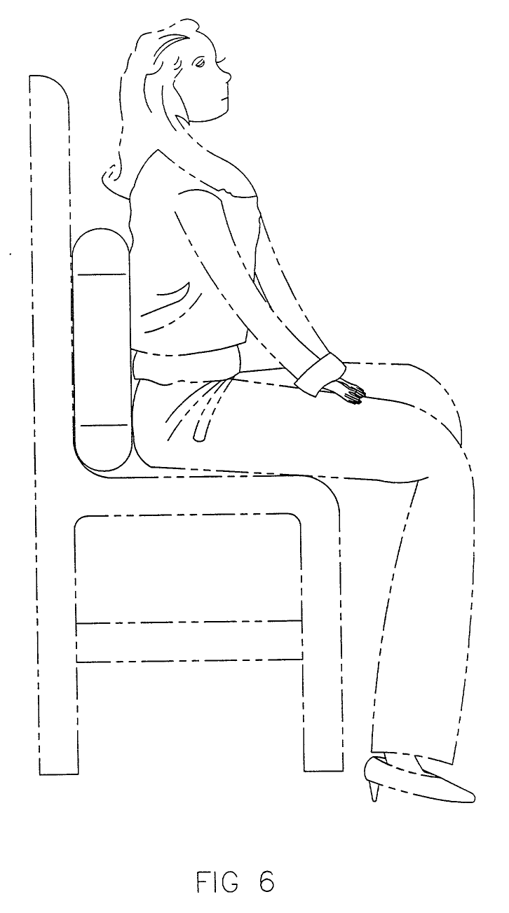

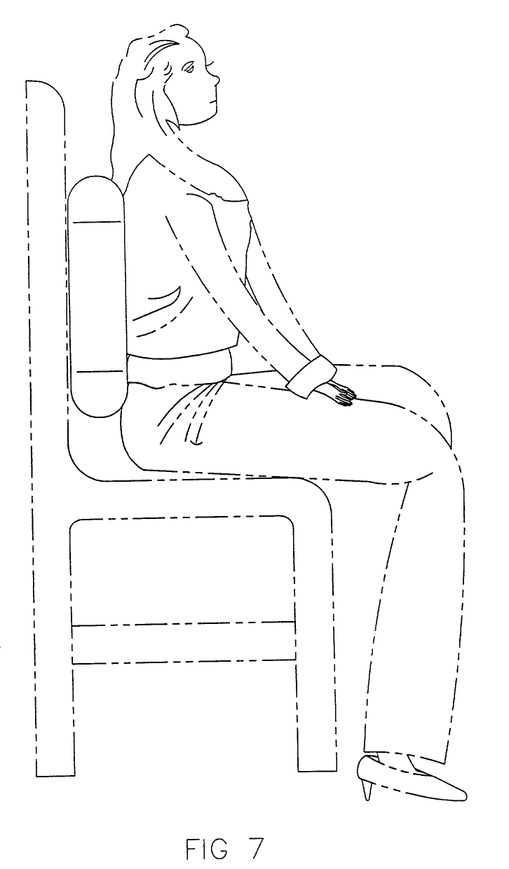

Referring to FIG. 6 and FIG. 7, as using the massage machine, depending on the necessary, it can be placed on the cushion, the back of chair or the mattress, if put on the back of chair, it will pad the waist part or back part of the human body, the two worm wheels 4 is driven by the motor 3 via the worm 5 to spin in counter-motion, so that the two symmetry kneading heads secured on the tips of the shafts 41 of the worm wheels 4 spin in counter-motion together, by means of stepped two spherical heads 2 on each connecting rod, effort pushing force on the muscle on the waist or the back of the human body to carry on the massage treatment imitating human's finger to knead and press the muscle of body to get the better massage effect.

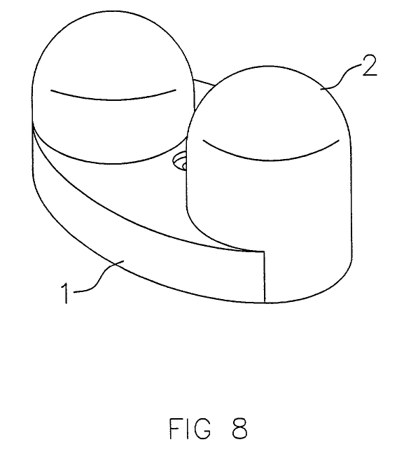

Referring to FIG. 8, the kneading head provided by the present invention can be an integrated body, just like integrating the connecting rod 1 with the two spherical heads 2 so as to decrease the number of the components, further to make the cutting process and the mounting process simplify and facilitate so as to decrease the production cost.

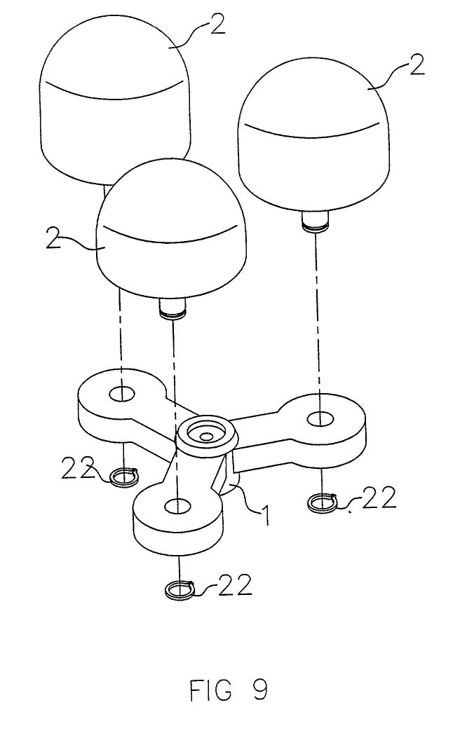

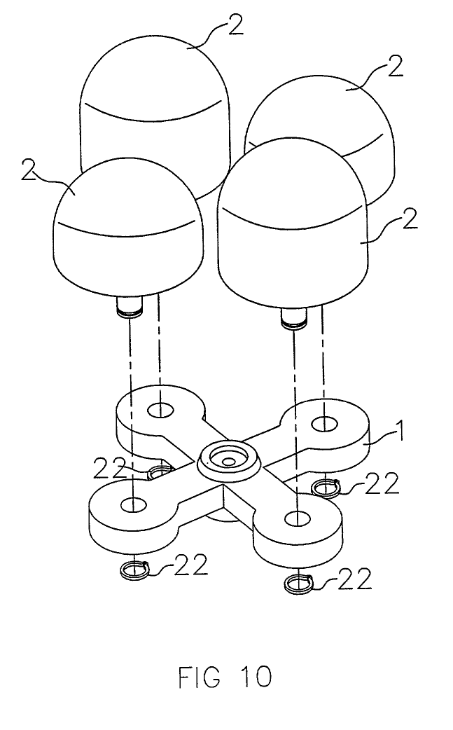

Referring to FIG. 9 and FIG. 10, for meeting the requirement of increasing the number of the spherical heads 2—reaching 3 or 4, the connecting rod 1 can be made into Y-shaped or X-shaped; all the spherical heads 2 located on the ends of the connecting rod 1 in different heights in stepped arrangement. In this way, the kneading action will be fined so as to get the better imitating massage effect.

The kneading head provided in the present invention can be used in other kinds of massage machines not limited in the kind of massage machine described in above.

I claim:

1. A kneading head of massage machine consisting of a connecting rod and a set of spherical heads. One set of the spherical heads includes two and more; all the spherical heads located on ends of the connecting rod in different heights.

2. A kneading head of massage machine as claimed in claim 1, wherein, the connecting rod has a number of plug-in sockets coordinating to the number of the spherical heads formed on the ends; every spherical head extends out a square plug-in pin downward with a ring groove approaching the bottom end, for plugging into the plug-in socket of the connecting rod and located by setting a binding ring into the ring groove from the back side, so in this way all the spherical heads are located on the ends of the connecting rod individually by the binding rings clamping into the ring grooves at the bottom of the spherical heads.

3. A kneading head of massage machine as claimed in claim 1, wherein, all the spherical heads can be integrated with the connecting rod into a whole body.

4. A kneading head of massage machine as claimed in claim 1 to claim 3, wherein, said a set of spherical heads includes two pieces located on the both ends of an I-shaped connecting rod in different heights separately.

5. A kneading head of massage machine as claimed in claim 1 to claim 3, wherein, said a set of spherical heads includes three pieces located on the three ends of a Y-shaped connecting rod in different heights separately.

6. A kneading head of massage machine as claimed in claim 1 to claim 3, wherein, said a set of spherical heads includes four pieces located on the four ends of a X-shaped connecting rod in different heights separately.
